(19) United States
(12) Patent Application Publication
(10) Pub. No.: US 2025/0243001 A1
(43) Pub. Date: Jul. 31, 2025

(54) zMatrix

(71) Applicant: Christopher Brennan, Alpharetta, GA (US)

(72) Inventor: Christopher Brennan, Alpharetta, GA (US)

(21) Appl. No.: 18/426,491

(22) Filed: Jan. 30, 2024

(51) Int. Cl. B65G 1/04

(52) U.S. Cl. CPC B65G 1/0478

(57) ABSTRACT

The present invention is a storage and retrieval system that is integral for sequencing and transporting products. In particular, the invention includes a plurality of slots arranged in a plurality of rows and columns with a plurality of movement mechanisms. The invention allows for a network of carrier members to move material in a way that is efficient by utilizing a novel technology. The proposed embodiment provides a unique experience for a user by providing an effective way to transport supplies.

The present application claims priority to the earlier filed provisional application having Ser. No. 63/456,251, and hereby incorporates subject matter of the provisional application in its entirety.

### BACKGROUND OF THE INVENTION

### Field of the Art

The disclosure relates to a convenient method for sequencing and transporting material by providing a high-density pick-rate system that is more effective over previous approaches. Additionally, it represents the most efficient and reliable system over previous applications on the market because of its simplistic design and use of network systems, methodology approach, and key mechanical components over traditional electrical/robotic components.

The embodiment manages inventory in a convenient and effective manner. It is worth noting that the disclosed embodiment referenced herein can be designed to meet various industries.

### Discussion of the State of the Art

Traditionally, supply systems include locations such as warehouses to store and remove supplies. Most warehouses or similar storage areas does not provide a dynamic approach to managing products in a high-density manner. To elaborate, when these products are stored for use, the approach is often to simply utilize a storage facility to statically store material and retrieve by utilizing physical means such as lifting devices etc. Prior methods have resulted in missed opportunities and inefficient processes and empty storage locations causing poor production outputs. These methods of storing and retrieving material do not allow for maximum output for storage, retrieval, and transporting material in an efficient manner. Accordingly, what is needed in the art is a novel manner of utilizing an embodiment that is integral for sequencing and tracking the use of essential materials. What is further needed in the art is a novel embodiment which incorporates moving mechanisms. What is further needed in the art is an embodiment that interfaces with a control unit. The proposed embodiment is significantly more efficient than existing systems in terms of density, throughput storage, retrieval, energy, and robustness. The embodiment is further ideal because its ultimate purpose is to conveniently transport inventory in an efficient manner, track time and date such inventory was transported, and track shipping information in a convenient manner.

The public is eager to welcome a method that would allow for transporting material efficiently by utilizing such a convenient apparatus.

### SUMMARY OF THE INVENTION

Accordingly, the inventor has conceived, in a preferred embodiment of the invention, a convenient storage and retrieval system for inventory tracking, storing, and transporting by utilizing a unique technology application.

According to a preferred embodiment of the invention, is a storage and retrieval system for warehouse management that allows for an inner storage surface which may come in several forms such as a smooth flat surface or one or more non-motorized omni-directional rollers or motorized rollers such as ball bearings. The inner storage surface is adjacent to an outer storage surface that is designed as a surface for moving material toward the outer perimeter of the embodiment. The outer perimeter further includes a movement surface where the material is moved horizontally along the perimeter this located adjacent to a plurality of slide walls. What is further disclosed is an embodiment that includes a method of moving carrier members north, south, east, or west depending on the most optimized direction. As a non-limiting example, the design of the inner storage surface is dependent on the size and weight of the carrier members dependent on the co-efficient of friction and the necessary power utilized to shift the length of an entire row or column one or more units as described. The ability of the system to move the carrier members in a synchronized manner plays a critical factor in determining the implementation used in the inner storage surface. The system can include any suitable number of carrier members. The purpose of the invention is to provide a unique method to store and retrieve products. The ability of the embodiment to manage critical material for supply purposes can save in expenses and will be welcomed among users. The embodiment also includes an outer storage surface which is located between the inner storage surface and the movement surface along the perimeter.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of what has been invented by the inventor.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1A is a perspective top-view of the storage and retrieval area in accordance with one or more aspects described herein.

FIG. 1B is a is a side-cross-sectional view configuration consistent with certain embodiments of the present invention depicting how the knob couples with the grooved plate.

FIG. 1C is a perspective view of the carrier member depicting the pegs in accordance with one or more aspects described herein.

FIG. 2A is a perspective close-up view of the storage and retrieval area to include slide popper mechanisms in accordance with one or more aspects described herein.

FIG. 2B is a perspective close-up view of the bottom surface of the carrier member depicting four holes in accordance with one or more aspects described herein.

FIG. 3A is a side-view configuration consistent with certain embodiments of the present invention.

FIG. 3B is a side-cross-sectional view configuration consistent with certain embodiments of the present invention.

FIG. 4A is a stage 1 process flow for the determination of selection of material consistent with certain embodiments of the present invention.

FIG. 4B is a stage 2 process flow for the determination of selection of material consistent with certain embodiments of the present invention.

FIG. 4C is a stage 3 process flow for the determination of selection of material consistent with certain embodiments of the present invention.

FIG. 5 is a system diagram for an exemplary system configuration consistent with certain embodiments of the present invention.

### DETAILED DESCRIPTION

The inventor has conceived, an embodiment for effectively transporting stored material.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Reference throughout this document to “red carrier member”, “red container” or similar terms means stored material that has been designated for use and will need to be extracted from the storage system. Thus, the appearances of such phrases or in various places throughout this specification are not necessarily all referring to the same embodiment.

Reference throughout this document to “blue carrier member”, “blue container” or similar terms means stored material that has not been designated for use and will need to remain within the storage system. Thus, the appearances of such phrases or in various places throughout this specification are not necessarily all referring to the same embodiment.

Reference throughout this document to “material”, “network of material”, “products” or similar terms means material for use with storage facilities and logistics etc. Thus, the appearances of such phrases or in various places throughout this specification are not necessarily all referring to the same embodiment. Furthermore, “material” may be described in any suitable manner by one or more embodiments without limitation.

Reference throughout this document to “material”, “network of material”, “products” or similar terms means material for use with storage facilities and logistics etc. Thus, the appearances of such phrases or in various places throughout this specification are not necessarily all referring to the same embodiment. Furthermore, “material” may be described in any suitable manner by one or more embodiments without limitation.

Reference throughout this document to “inner storage surface”, “primary storage area” or similar terms means a storage surface that is located in the central portion of the embodiment for storing material. Thus, the appearances of such phrases or in various places throughout this specification are not necessarily all referring to the same embodiment.

Reference throughout this document to “outer storage surface”, or similar terms means a storage surface that is located in an area between the central portion of the embodiment and the outer perimeter of storage surface. Thus, the appearances of such phrases or in various places throughout this specification are not necessarily all referring to the same embodiment.

Reference throughout this document to “movement surface”, or similar terms means an area adjacent to perimeter where material stored within carrier members are moved along slide walls for output. Thus, the appearances of such phrases or in various places throughout this specification are not necessarily all referring to the same embodiment.

Materials described or referenced herein will sometimes be described in singular form for clarity. However, it should be appreciated that particular embodiments may include multiple instantiations of a material unless noted otherwise. Surfaces in some embodiments can be understood as representing segments or portions of those embodiments. Alternate implementations are included within the scope of embodiments of the present invention would be understood by those having ordinary skill in the art.

Headings of sections provided in this patent application and the title of this patent application are for convenience only and are not to be taken as limiting the disclosure in any way. A description of an embodiment with several components in connection with each other does not imply that all such components are required.

The embodiment is ideally designed as a system for selecting specific material necessary for order fulfillment by utilizing a network system and critical components to move material. The key process of the invention is that each row or column in its entirety is independently pushed or shifts exactly one storage unit in a preferred direction. Shifting is done by simultaneously moving horizontally in calculated steps. These steps are repeated in a continuous cycle. During the shift, a carrier member 3 will be shifted horizontally (north or south) one unit in a column. Multiple carrier members 3 may be shifted within rows and columns simultaneously during a designated shifting process. During the horizontal shifting process, a row may be shifted either left or right depending on orientation of the inbound and outbound direction of the embodiment. Additionally, the horizontal process shift can move either left or right simultaneously during the shifting process. The resulting process shift may extract designated carrier members 3 from the storage surface onto a movement surface (2a, 2b, 2c, 2d) represented in the figures. As illustrated, there are spaces (4a, 4b, 5a, 5b) which represent inbound and outbound points of the automated storage for carrier members 3. It can be appreciated that the movement mechanisms described are just one of a number of mechanisms that could be used. The mechanisms can be designed for movement by using approaches known in the arts such as segmented belt conveyors, power roller conveyors etc. Moreover, the left 4a and right 4b surface squares are diagonal from each other and represent inbound carrier members to enter the storage system and the right 5a and left 5b surfaces are diagonal from each other and represent outbound points for the carrier members 3 leaving the storage system. It will be appreciated that the inbound and outbound areas can be designed to be moveable in a vertical direction by utilizing a lift structure (not shown) for elevating and or lowering material to the movement surface along the lower level if the system is designed with multiple levels. In a non-limiting example, the movement surfaces can also consist of segmented horizontal slide wall mechanisms with grips that will latch to each carrier member by grabbing and pulling the carrier members in a direction against the slide wall or similar movement mechanisms known in the art to move a container a predetermined distance during the shifting process. Utilizing a control unit for example, the shifting process occurs on all movement surfaces once the step is calculated based on availability of the next space. The left movement surface shall always move a carrier member from left inbound toward the left outbound 5b. The right movement surface shall always move a carrier member from right inbound toward the right outbound. Red carriers represent carrier members that are designated to be retrieved from the system. Blue carriers represent carrier members that are not designated for retrieval. Using the described continuous recycling procedures and movements of the movement surface, red carrier members are continually shifted north or south, then east or west toward the nearest perimeter of the storage system. This effectively creates a zig-zag movement of red carrier members 2 to make their way towards the movement surface. Once a red carrier member is placed on the movement surface, the system will move it towards the connected outbound location utilizing a network of slide walls. During the shifting process, it is normal for a blue carrier member 1 to be pushed onto the movement surface. The blue carrier member will either be pushed off the movement surface or back into the outer storage surface 28 if there is available space within the rows or columns or it will be moved along the movement surface towards the outbound point. If a blue carrier member 1 is moved and the new location contains an empty space, then the system will attempt to push in the blue carrier member into a row or column of the outer storage surface 28. Should a blue carrier member reach the final movement surface segment before the outbound without having found an empty space, then the system will attempt to push the carrier member into the storage surface provided the opposite movement surface is empty. Upon an attempted insertion and the outer storage surface 28 is full and the opposite movement is occupied, then the carrier member will not be pushed in and will remain along the movement surface until a space becomes available. This action, if the row or column contain carrier members in all primary storage spaces will cause a carrier member on the opposite side of the outer storage surface 28 to be extracted onto the opposing movement surface. The system will then perform the same actions as just described by moving the carrier member in the opposite direction as before in search of a row or column with an empty position. This system is effectively a recirculation process for carrier members and will ensure that any blue carrier members 1 be redeposited in a location within the storage surfaces. With this described behavior, blue carrier members do not leave the system. Representing containers that have been designated by a network to be extracted, the red carrier members 2 will be moved into the outbound surface and thus leave the system. Following a red carrier member being placed on the movement surface, the system will insert a new carrier member at the inbound point depending on space and calculated step at the time of insertion. This new carrier member may or may not contain adequate inventory. Intake of a “new” carrier member and retrieval of a “designated” carrier member can also be performed simultaneously since there are multiple inbound and outbound surfaces. In this case, “shortest paths” for placing the “new” carrier member and retrieving the “designated” carrier member can be simultaneously computed and the movement mechanism can operate based on both paths. Any newly inserted carrier member is handled as a blue carrier member 1, unless the newly added carrier member contains adequate inventory for a known pick cycle designated by the system. If a newly added carrier member contains adequate inventory for an existing pick cycle, the system will subsequently designate the carrier member as “red” and be transported along the movement surface toward an outbound point. When any newly inserted carrier member enters the system, it shall be moved either onto the movement surface depending on the designated horizontal shifting process being performed at the time of insertion. For example, if the inner storage surface is empty and a huge load of “new” carrier members have to be loaded, then all the surfaces can be configured as “inbound surfaces”. Similarly, if the surface area needs to be emptied or all or many carrier members have to be unloaded, then all the surfaces can be configured as “outbound surfaces.”

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

In the following description, for purposes of explanation, numerous specific details are set forth in order to provide a thorough understanding of the claimed subject matter. It may be evident, however, that the claimed subject matter may be practiced without these specific details. Various structures and/or features are not necessarily drawn to scale. In other instances, structures and features are shown in two-dimensional diagram form in order to facilitate describing the claimed subject matter.

As provided herein, a storage and retrieval system that includes a system in order to securely store and remove material for storage in a convenient manner. As can be shown in the figures, the resultant system is ideal to store and transport material. In a non-limiting example, the embodiment could be used for all types material and products for retrieval and storage purposes when needed. Specifically, the embodiment allows for high density storage and extraction of materials. The embodiment is ideal for commercial and private application that requires a user to secure and transport material.

The storage and retrieval system is shown as a perspective view which comprises a plurality of carrier members designated as blue carrier members and red carrier members. As depicted, the embodiment further comprises inbound surfaces and outbound surfaces. The drawing also shows moving surfaces. A plurality of grips are utilized for grabbing the pegs of the carrier member in an effort to transport the carrier members toward the slide walls. The depiction further shows the actuators that operate the grips as shown ideally positioned behind the plurality of grips. The figure shows the plurality of slide walls that are positioned along the perimeter of the storage surface. The slide walls are operational by a plurality of solenoids that are coupled to a plate positioned directly behind the slide walls and connected by a knob that is inserted into a groove extending vertically along the slide wall. The embodiment has an overall rectangular geometrical shape to include an outer perimeter. It will be appreciated, however, that the embodiment can be designed in various widths and lengths if geometrically necessary.

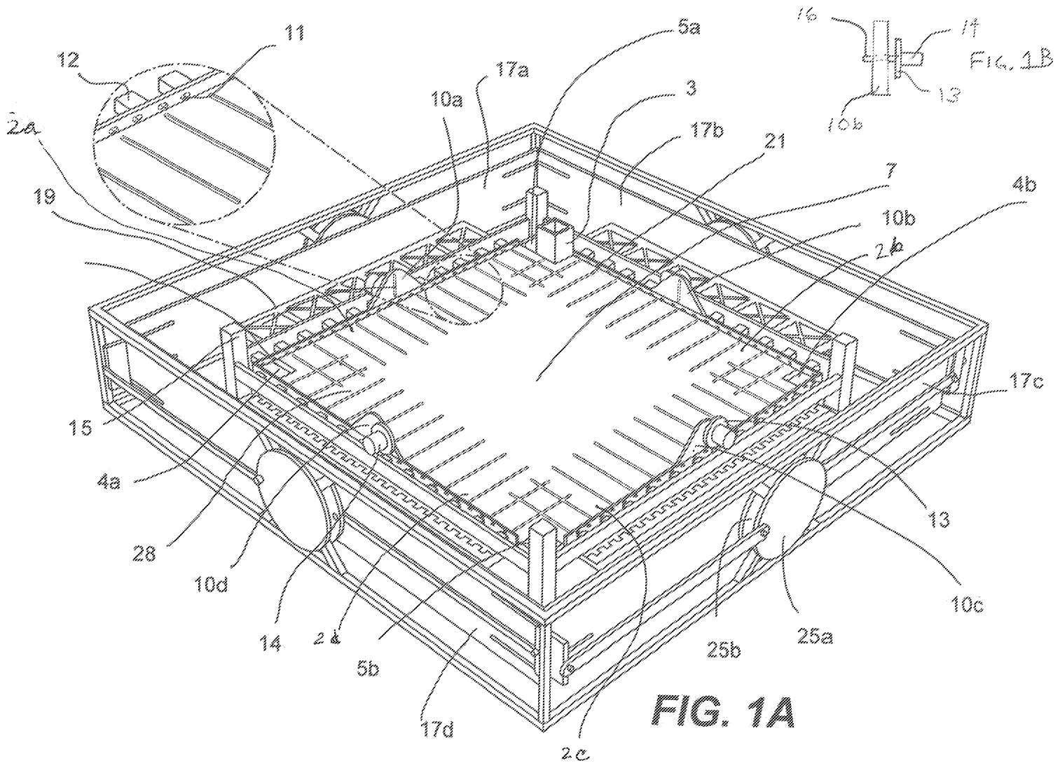

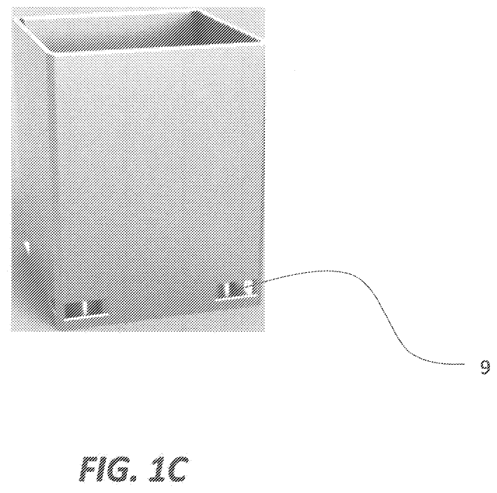

The claimed subject matter is now described with reference to the drawings, wherein like reference numerals are used to refer to like elements throughout. The embodiment includes at least one level of the inner storage surface 7, an outer storage surface 28, and a movement surface 29 that will include various moveable carrier members 3. With reference to the attached figures, as illustrated in FIGS. 1A, 1B, 1C the embodiment is directed generally to a system for retrieving and storing material, and in particular to provide a system that includes a series of moveable carrier members 3 to transport stored material. The carrier member is designed with pegs 9 at each corner of the base in a manner for a segmented conveyor system such as a slide walls (10a, 10b, 10c, 10d) to move the carrier members 3 along the perimeter by utilizing a set of grips 11 that latch onto the pegs 9 located along the corners of the carrier members 3 for horizontal movement. The grips 11 will couple with the carrier members 3 in an effort to move horizontally along the movement surface along the length of each side of the embodiment via the slide walls (10a, 10b, 10c, 10d) in a manner that will cause the set of grips 11 to engage the pegs 9 by utilizing a plurality of actuators 12 to move the carrier members 3 a predetermined distance that includes a series of engagements and releasing of the carrier members 3 by the set of grips 11 until the carrier members 3 has moved to its designated location for output. The set of grips 11 are driven by a plurality of actuators 12 that allow the set of grips 11 to latch outwardly and inwardly. In a non-limiting example, the slide walls 10 move back and forth along the outer perimeter in an oscillating manner (left to right and visa versa) via a rotating plate 13 that is coupled to a servo motor 14 of adequate torque that is positioned behind the slide walls 10. It can be appreciated that the servo motor 14 is just one of a number of mechanisms that could be used to achieve the oscillation movement. The embodiment can be designed by using approaches known in the art to accomplish similar movement such as a socket gear and chains as an example. The slide wall includes a slotted groove 15 of a predetermined length extending vertically that receives a knob extending 16 perpendicular from the rotating plate that provides a movement action for the slide walls 10.

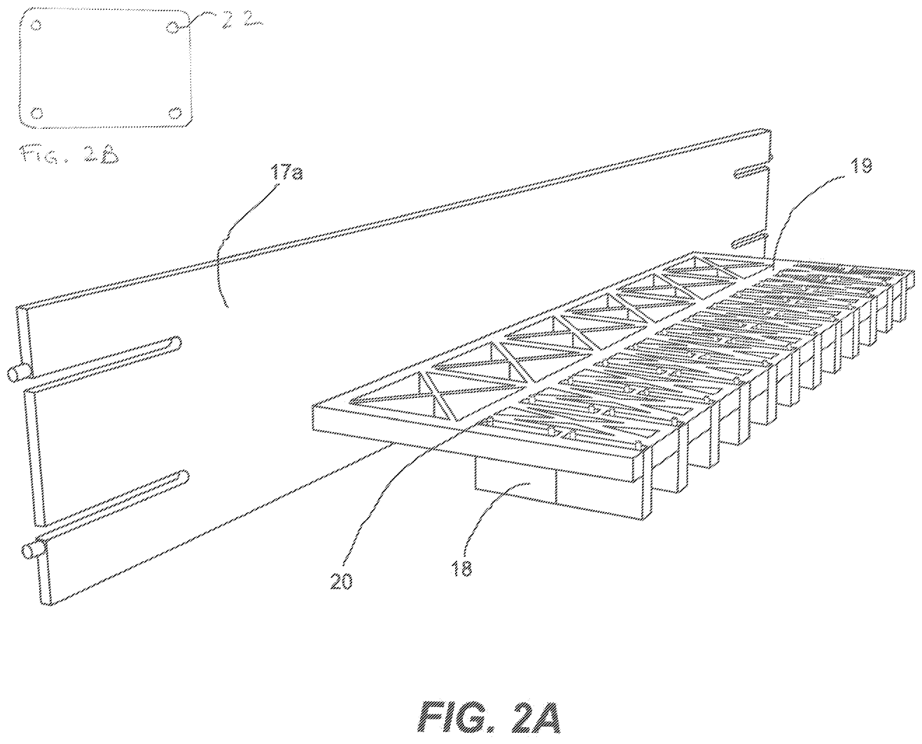

Turning to FIGS. 2A, 2B (in conjunction with FIG. 1) the embodiment further includes a plurality of compression walls (17a, 17b, 17c, 17d) that are utilized to transfer the extending tray structures 19 in sequenced manner. The plurality of compression walls (17a, 17b, 17c, 17d) further includes a motor or similar devices located along the base of the plurality of compression walls (17a, 17b, 17c, 17d) and a plurality of slide poppers 20 that are attached to the extending tray structures 19. The slide poppers 20 extends upward to the carrier members 3 through a plurality of grooved slots 21 equally spaced along the outer storage surface 18 when prompted by the system. The plurality of compression walls (17a, 17b, 17c, 17d) are attached to the extending trays 19 positioned under the outer storage surface 18 that includes slide poppers 20 for engaging the bottom portion of the carriers 3 by utilizing a control unit 504 that control the synchronization of the system. Additionally, the carriers 3 has at least four holes 22 in the base for receiving the slide poppers 20 which is designed to be upwardly inserted into the holes 22 when necessary to move the carrier members 3 (either from the outer storage surface or to an inner storage surface). The plurality of compression walls (17a, 17b, 17c, 17d) move in a synchronized manner to ensure that material is transported in an organized and controlled fashion.

The plurality of compression walls (17a, 17b, 17c, 17d) are located along the perimeter of the embodiment to extract or insert the carrier members 3. In a preferred embodiment, the plurality of compression walls (17a, 17b, 17c, 17d) will be utilized across multiple levels of the embodiment if constructed as a multi-tiered system. The plurality of compression walls moves a plurality of trays under the storage surface in a synchronized manner to move the carrier members in an out bound direction or in bound direction. As a result of the inner storage surface 7, the embodiment will result in various materials being conveniently transported by utilizing individual rows and columns. As a non-limiting example, the storage and retrieval system will include at least one motor and or a plurality of solenoids 18 for the plurality of slide poppers 20, but other devices known in the art can be utilized. Additionally, the embodiment includes an out-push and inner-push operation that provides a means of moving material when appropriate. In a non-limiting example, the total length of the apparatus can be designed to fit any number of spaces and levels for multi-tiered storage to transport material vertical.

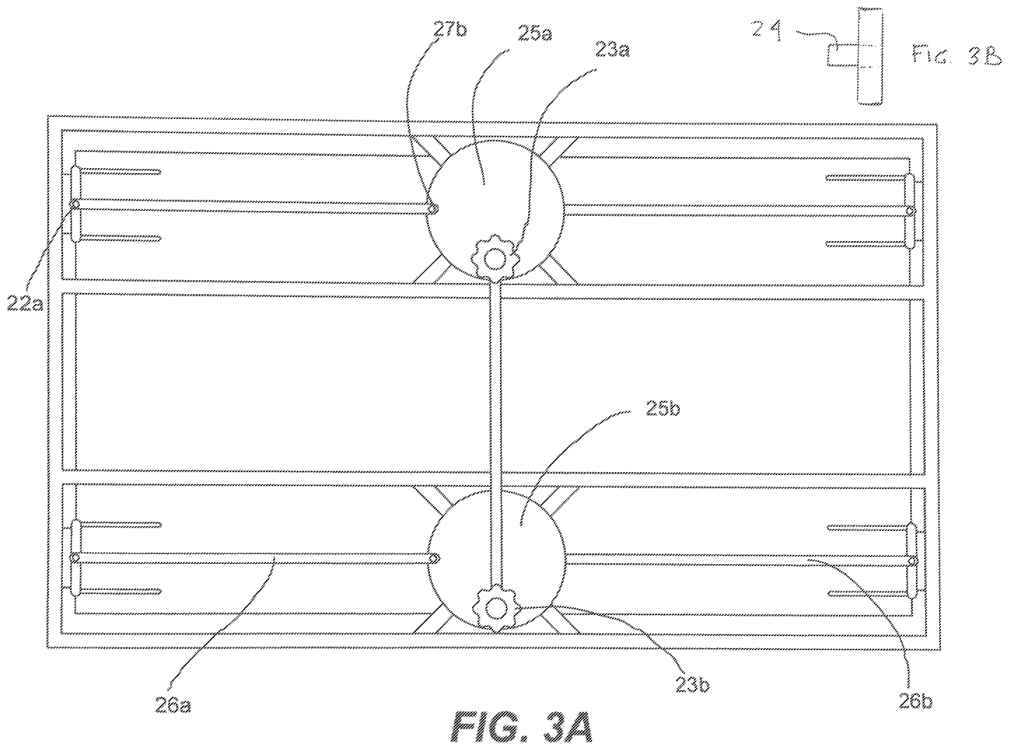

Turning to FIGS. 3A, 3B this figure presents a side-view configuration consistent with certain embodiments of the present invention. This figure presents a side-view of the embodiment for how two drive wheels can be positioned in the event that a multi-tiered storage system is operational. The drive wheels always rotate in the same direction causing the compression of the connected compression walls. The figure further depicts how a connecting rod is utilized to ensure proper rotation between two drive wheels while a multi-tiered storage system is utilized. At least two connecting rods extend along the side of the embodiment and connects to the slide walls at a distal end causing the slide walls to oscillate in a synchronized motion. In a non-limiting example, the basis of the invention is that carrier members 3 are stored in a high-density alignment of rows and columns that are moveable horizontally in a north, south, east, or west direction. As shown in the figures, there is a first drive wheel 23a and a second drive wheel 23b or similar devices located along all four sides (more if the system is multi-tiered). There is a first drive wheel 23a positioned at the top and second drive wheel 23b positioned at the bottom which would be connected to each other to transfer synchronized power if constructed as a multi-tiered system. The drive wheels (23a, 23b) include a central shaft 24 and two plates (25a, 25b) that includes at least two bolts (27a, 27b). There are at least two connecting rods (26a, 26b) that extend horizontally from the plates that connects to the plurality of compression walls (17a, 17b, 17c, 17d) at a distal end. The drive wheels (23a, 23b) cause the compression walls (17a, 17b, 17c, 17d) to move both inward and outward by utilizing the at least two connecting rods (26a, 26b) during operation. The drive wheels rotate along a central shaft and operational by a base motor (not shown) that is located behind the drive wheels in an ideal location. The illustrations ideally shown represents one level of the storage system with the levels vertically stackable enabling multi-tiered storage.

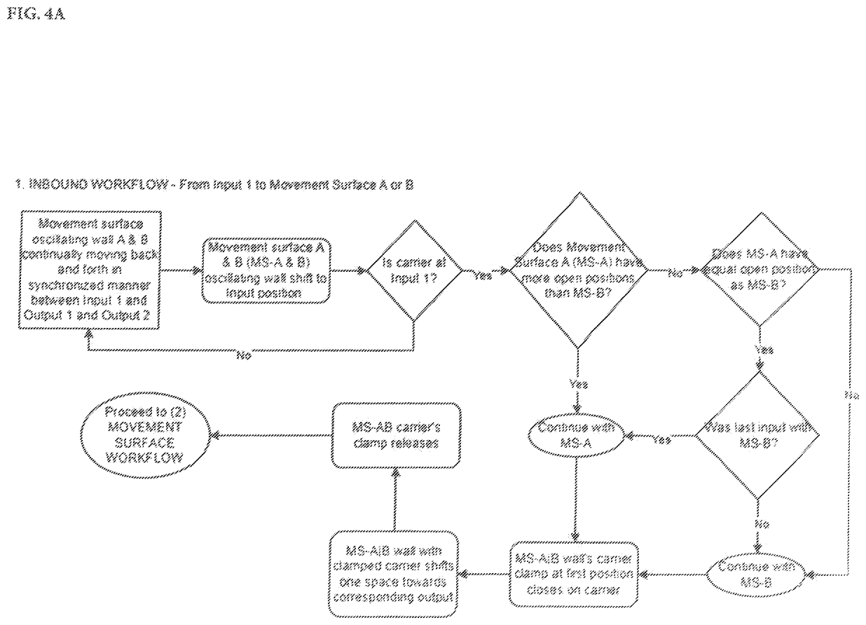

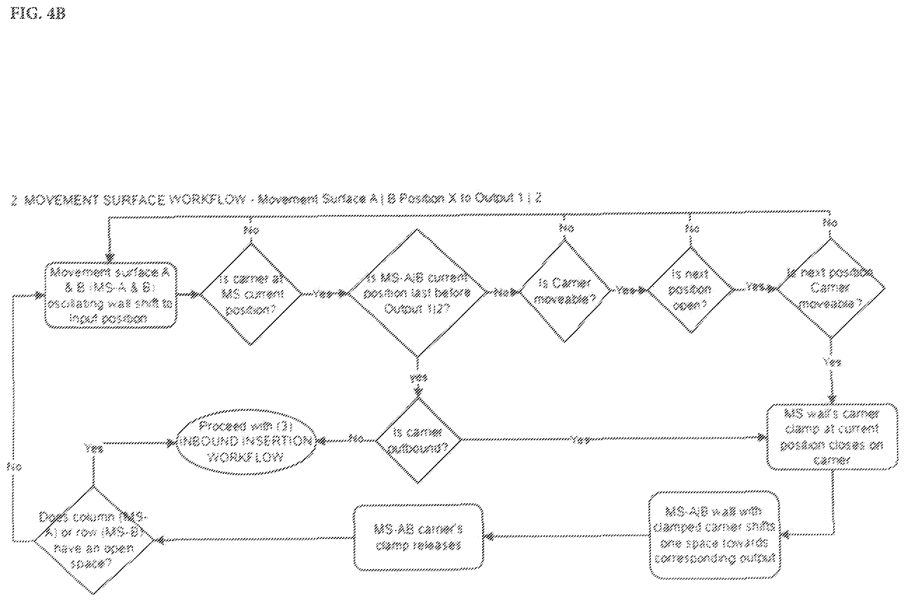

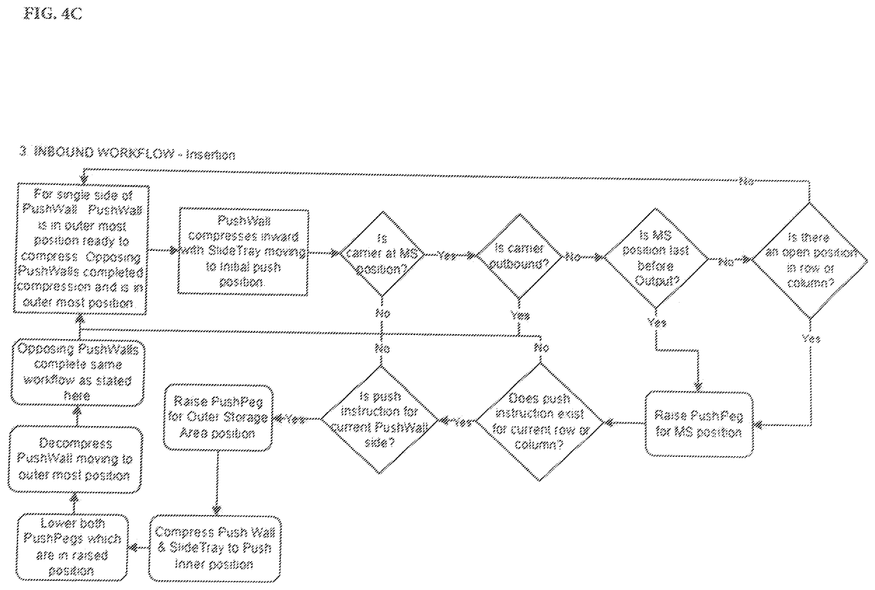

Turning now to FIGS. 4A, 4B, 4C are flow charts of an exemplary method that depicts how the system transports material. The following further illustrates a process workflow for determining the proper movement of carrier members in 3 distinct stages of the workflow. In some embodiments, process may be accomplished with one or more additional operations not described, and/or without one or more of the operations discussed. Additionally, the order in which the processes are illustrated in FIGS. 4A, 4B, 4C and described below is not intended to be limiting. The one or more processes described below may include one or more components configured via network to deliver material or designed for material to be received manually by a user.

### FIG. 4A (Stage 1)

Step 1: (410) Receive material for the system via network components to be operable in a selected mode. The system will transport the material once the network is operational. It will be appreciated that the operations can be initially be either network or via a user.

Step 2: (420) Movement of compression wall A & B in a continuous synchronized manner between input 1 and output 1 and output 2. A determination whether a carrier member is at input 1.

Step 3: (430) Determine if movement surface A (MS-A) have more open positions than movement surface B (MS-B). A determination is made whether MS-A have equal open positions as MS-B.

Step 4: (440) At a movement surface among a plurality of movement surfaces, the new carrier member from the first inbound surface or the second inbound surface will place material at an available slot.

Step 5: (450) Once all operations have been satisfied then proceed to Stage 2 of the movement surface workflow.

### FIG. 4B (Stage 2)

Step 6: (460) Movement Surface A & B (MS A&B) continuous oscillating wall shifts to input position.

Step 7: (470) The system makes a succession of determination of based on current position for movement of carrier members.

Step 8: (480) Once all operations have been satisfied then the system will proceed to Stage 3 of the movement surface workflow.

### FIG. 4C (Stage 3)

Step 9: (490) The system will arrange a single set of compression walls in an outer most position while opposing compression walls are in an inward position.

Step 10: (495) While the compression walls push inward, the trays move to the initial push position completing the operation of the embodiment. In a non-limiting example, the above processes are preferably operational by an ERP/WMS system or similar network system that determines the number of picks for the movement of the carrier members.

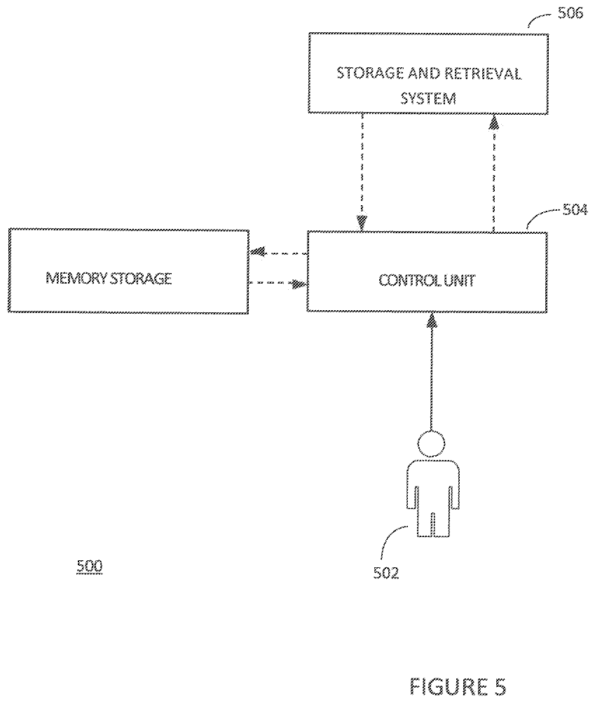

Turning now to FIG. 5, this figure presents a system diagram 500 for an exemplary system configuration consistent with certain embodiments of the present invention. A user 502 may initiate the control unit 504. When the system is initiated, the control unit 504 will send information data collected, containing retrieval information which transmits data to the storage and retrieval system 506. The transmitted information is useful for movement of material via the carrier members.

While the present invention has been described above in terms of specific embodiments for purposes of illustration, it is to be understood that the invention is not limited to these disclosed embodiments. Likewise, while “the invention” or “present invention” may have been referred to at the times in this disclosure those terms are not intended to limit the scope of this disclosure or to suggest in any way that there is a single version or embodiment. While the invention relates generally to a system for storing and retrieving material, the storage and retrieval devices that fall within the scope of this disclosure may include a variety of optional features, which do not need to be present in every version or embodiment. Various modifications and changes can be made without departing from the spirit of the invention. In fact, modifications and other embodiments of the invention will also come to mind of those skilled in the art to which this invention pertains, and which are intended to be and are covered by both this disclosure and the appended claims. It is indeed intended that the scope should be determined by proper interpretation and construction of the appended claims and their legal equivalents, as understood by those skilled in the art relying upon the disclosure in this specification and the attached drawings.

The skilled person will be aware of a range of possible modifications of the various embodiments described above. Accordingly, the present invention is defined by the claims and their equivalents.

What is claimed is:

1. A system for warehouse management, the system comprising:
an inner storage surface comprising a plurality of slots arranged in a plurality of rows and columns, an outer storage surface, the plurality of slots configured to accommodate a plurality of carrier members respectively, the outer storage surface having a plurality of corners, at least one slide wall, the at least one slide wall having a grooved slot that extends vertical along the central area of the at least one slide wall;
wherein the at least one slide wall has a plurality of grips, a plurality of movement surfaces arranged along the edges of the outer storage surface adjacent to the plurality of carrier members forming a plurality of intersection areas adjacent to the plurality of corners of the inner storage surface, wherein said carrier members include four holes in a base of said carrier members;
a first inbound surface and a second inbound surface arranged at a first intersection area and a third intersection area adjacent to a first set of opposite corners of the outer storage surface;
a first outbound surface and a second outbound surface arranged at a second intersection area and a fourth intersection area adjacent to a second set of opposite corners of the outer storage surface;
a plurality of movement mechanisms operatively coupled with the plurality of movement surfaces, the plurality of movement mechanisms configured to:
move the plurality of carrier members horizontally such that the movement mechanism facilitates an intake of a new carrier member in the outer storage surface, from any of the first inbound surface or the second inbound surface and a retrieval of a designated carrier member from the plurality of carrier members, of the inner storage surface, from any of the first outbound surface or the second outbound surface, using the plurality of movement surfaces; and
a plurality of compression walls operative to move the carrier members via a first and second drive wheel, the plurality of compression walls include a tray having a plurality of slide poppers; the plurality of compression walls operative to move the carrier members, the plurality of compression walls are coupled to a plurality of oscillating plates operatively coupled to a servo motor, wherein said plurality of oscillating plates includes a knob.

2. The system as claimed in claim 1, wherein the movement mechanism is configured to move the plurality of carrier members in a horizontal direction.

3. The system as claimed in claim 1, wherein the first drive wheel is coupled to at least two at least two connecting rods that are attached to said plurality of compression walls at a distal end; wherein said plurality of compression walls are further attached to a plurality of extending trays.

4. The system as claimed in claim 1, wherein said first and second drive wheels includes a first and second central drive shaft for rotation.

5. The system as claimed in claim 4, wherein said first and second drive wheels further includes a motor at the base of said first and second drive wheels for operation of said first and second drive wheels.

6. The system as claimed in claim 1, wherein the plurality of carrier members includes pegs at each corner of a base along the carrier member.

7. The system as claimed in claim 1, wherein the movement mechanism is configured to move the new carrier member from the first inbound surface or the second inbound surface to one of the plurality of slots in the outer storage surface; the plurality of slots will receive a slide popper to engage with the carrier members via said four holes in the base of the carrier members.

8. The system as claimed in claim 1, wherein the movement mechanism is configured to move a designated carrier member from one of the plurality of slots in the inner storage surface to the first outbound surface or the second outbound surface.

9. The system as claimed in claim 1, wherein the movement mechanism facilitates a horizontal movement of at least a row from the plurality of rows in a positive or a negative x-direction by one carrier member.

10. The system as claimed in claim 1, wherein the system comprises a plurality of compression walls, operatively coupled with the movement mechanism, configured to push back one or more carrier members, other than the designated carrier member, from the plurality of horizontal movement surfaces into the inner storage surface such that the one or more carrier members other than the designated carrier member are prevented from reaching the first outbound surface or the second outbound surface.

11. The system as claimed in claim 1, wherein the system comprises a control unit in communication with the movement mechanism, wherein the control unit comprises a processor coupled with a memory, wherein the memory stores one or more instructions executable by the processor for the intake of the new carrier member into the storage surface and the retrieval of the designated carrier member from the inner storage surface.

12. A method for warehouse management, the method comprising:
receiving, via a movement mechanism, an intake of a new carrier member into a storage surface comprising a plurality of slots arranged in a plurality of rows and columns, the plurality of slots configured to accommodate a plurality of carrier members respectively, the outer storage surface having a plurality of corners, wherein the intake of the new carrier member comprises:
receiving, at a first inbound surface or a second inbound surface, the new carrier member;
transferring, at a movement surface among a plurality of movement surfaces, the new carrier member from the first inbound surface or the second inbound surface, via the movement mechanism operatively coupled with the plurality of movement surfaces; and
placing, at a slot among the plurality of slots, the new carrier member into a row among the plurality of rows or a column among the plurality of columns, via the movement mechanism; and
retrieving, via the movement mechanism, a designated carrier member from the plurality of carrier members accommodated in the plurality of slots arranged in a plurality of rows and columns in the inner storage surface, wherein the retrieving the designated carrier member comprises:
selecting, at the inner storage surface, the designated carrier member to be removed from the plurality of carrier members;
transferring, at the movement surface among the plurality of movement surfaces, the designated carrier member from the plurality of carrier members via the movement mechanism operatively coupled with the plurality of movement surfaces;
removing, at a first outbound surface or a second outbound surface, the designated carrier member, via the movement mechanism.

13. The method as claimed in claim 8, wherein the method comprises shuffling, at the storage surface, the plurality of carrier members for the receiving the intake of the new carrier member and/or retrieving the designated carrier member, via the movement mechanism, wherein the shuffling comprises a horizontal movement of the plurality of movement surfaces via the movement mechanism, and wherein the horizontal movement of the movement surface among the plurality of movement surfaces facilitates a horizontal movement of at least a row from the plurality of rows in a positive or a negative x-direction by one carrier.

14. The method as claimed in claim 8, wherein the method comprises pushing, into the storage surface, one or more carrier members other than the designated carrier member, wherein the pushing facilitates prevention of the one or more carrier members from reaching the first outbound surface or the second outbound surface, and wherein the method is stored in a memory as computer readable method to be executable by a processor of a control unit in communication with the inner storage surface and the movement mechanism.

15. A system for warehouse management, the system comprising:
an inner storage surface comprising a plurality of slots arranged in a plurality of rows and columns, the plurality of slots configured to accommodate a plurality of carrier members respectively, an outer storage surface, the outer storage surface having a plurality of corners;
a plurality of movement surfaces arranged along the edges of the outer storage surface adjacent to the plurality of carrier members forming a plurality of intersection areas adjacent to the plurality of corners of the outer storage surface;
a first inbound surface and a second inbound surface arranged at a first intersection area and a third intersection area adjacent to a first set of opposite corners of the outer storage surface;
a first outbound surface and a second outbound surface arranged at a second intersection area and a fourth intersection area adjacent to a second set of opposite corners of the outer storage surface; and
a movement mechanism operatively coupled with the plurality of movement surfaces, the movement mechanism comprising:
a plurality of solenoids; and
a plurality of compression walls; and
wherein the movement mechanism is configured to receive a network of material via the plurality of carrier members arranged in the plurality of rows and columns, horizontally, such that the movement mechanism facilitates an intake of a new carrier member in the inner storage surface, from any of the first inbound surface or the second inbound surface and a retrieval of a designated carrier member from the plurality of carrier members, of the storage surface, from any of the first outbound surface or the second outbound surface, using the plurality of movement surfaces.

16. A system for warehouse management, the system comprising:
an inner storage surface comprising a plurality of slots arranged in a plurality of rows and columns, an outer storage surface, the plurality of slots configured to accommodate a plurality of carrier members respectively, the outer storage surface having a plurality of corners;
a plurality of movement surfaces arranged along the edges of the outer storage surface adjacent to the plurality of carrier members forming a plurality of intersection areas adjacent to the plurality of corners of the outer storage surface;
a first inbound surface and a second inbound surface arranged at a first intersection area and a third intersection area adjacent to a first set of opposite corners of the outer storage surface;
a first outbound surface and a second outbound surface arranged at a second intersection area and a fourth intersection area adjacent to a second set of opposite corners of the outer storage surface; and
a movement mechanism operatively coupled with the plurality of movement surfaces, the movement mechanism configured to:
receive a network of material via the plurality of carrier members arranged in the plurality of rows and columns, horizontally, such that the movement mechanism facilitates an intake of a new carrier member from an exterior surface to an interior surface of the inner storage surface, from any of the first inbound surface or the second inbound surface and a retrieval of a designated carrier member from the plurality of carrier members, from the inner surface to the outer storage surface, from any of the first outbound surface or the second outbound surface, using the plurality of movement surfaces.

17. The system as claimed in claim 1, wherein the movement mechanism is configured to move the plurality of carrier members in a clockwise and/or anti-clockwise material flow direction via the plurality of movement surfaces, for the intake of the new carrier member in the inner storage surface and the retrieval of the designated carrier member from the plurality of carrier members of the inner storage surface.

18. The system as claimed in claim 13, wherein the movement mechanism comprises a simultaneous horizontal movement of the plurality of carrier members facilitating the movement of the plurality of carrier members in the clockwise and/or anti-clockwise material flow direction.

19. The system as claimed in claim 1, wherein the movement mechanism comprises at least one predefined movement path of the plurality of carrier members for each intake of the new carrier member and/or each retrieval of the designated carrier member, wherein the predefined movement path is the shortest movement path travelled by each carrier member of the plurality of carrier members computed by the control unit.

20. The system as claimed in claim 14, wherein the movement mechanism facilitates a simultaneous intake of the new carrier member and retrieval of the designated carrier member.

21. The method as claimed in claim 8, wherein the method comprises:
receiving an intake of a plurality of new carrier members simultaneously from the first inbound surface and the second inbound surface; and
retrieving a plurality of designated carrier members simultaneously from the first outbound surface and the second outbound surface.

22. The system as claimed in claim 1, wherein the movement mechanism comprises an intake of a plurality of new carrier members and a retrieval of a plurality of designated carrier members simultaneously, via the first inbound surface or the second inbound surface and the first outbound surface or the second outbound surface, respectively.

23. The system as claimed in claim 11, wherein any one or all of the first inbound surface, the second inbound surface, the first outbound surface and the second outbound surface are reconfigured based on an operation load of the network of material, wherein the operation load of the network of material comprises receiving a maximum load of the new carrier member or a maximum load of the designated carrier member.
